(19) United States
(12) Patent Application Publication
(10) Pub. No.: US 2022/0351133 A1
(43) Pub. Date: Nov. 3, 2022

(54) MODELING DYNAMIC MATERIAL FLOW IN GENERATIVE DESIGN USING TOPOLOGICAL MAPS

(71) Applicant: Accenture Global Solutions Limited, Dublin (IE)

(72) Inventors: Nicholas Akiona, Saratoga, CA (US); Haitao Zhu, Compton, CA (US); Eric Tang, Cupertino, CA (US); Ana Maria Tudor, Belmont, CA (US)

(21) Appl. No.: 17/246,882

(22) Filed: May 3, 2021

(51) Int. Cl. G06Q 10/08; G06Q 10/06; G06F 30/10; G06K 9/62

(52) U.S. Cl. CPC G06Q 10/08355; G06Q 10/087; G06Q 10/0833; G06Q 10/06315; G06F 30/10; G06K 9/6218

(57) ABSTRACT

Implementations include providing a set of parameters, generating a set of zones based on the set of parameters, each zone associated with a set of tasks to be performed for material flow during a process, for each zone, automatically generating a zone topological map as a zone graph including a set of nodes and a set of edges, the set of nodes including a set of area nodes and a set of terminal nodes, each area node representing a path that can be traveled along, each terminal node representing locations where a task is performed during of the process, and merging zone topological maps to provide a facility topological map modeling space within which mobile agents execute tasks, merging including connecting a node of a first zone topological map with a node of a second zone topological map by an edge.

### BACKGROUND

Enterprises conduct operations to provide goods and services to customers. Enterprise operations are often conducted within and/or between facilities. Example facilities can include factories, warehouses, and distribution centers. Some facilities include elements that are dynamic (e.g., location of elements change over time). An example dynamic facility can include a warehouse with mobile agents (e.g., workers, vehicles, robots). Some facilities are partially or fully automated.

The design of facilities can significantly impact multiple aspects of enterprise operations. Example aspects can include efficiency, cost, scalability, capacity, and flexibility. In view of this, approaches for facility design often seek to optimize one or more aspects. An increasingly popular design approach includes generative design, which can be described as a design exploration process that explores multiple design options based on an initial design goal and requirements.

The design process can be supported using computer-implemented tools, such as computer-aided design (CAD) programs. Example design tools include AutoCAD (provided by Autodesk, Inc.) and Tecnomatix (provided by Siemens AG). However, design tools can have limitations. For example, in terms of facility design, traditional design tools tend to focus on a particular industry, such as manufacturing. As another example, generative design tools provide functionality for design of static environments (e.g., offices, homes), there is an absence of functionality for dynamic environments.

### SUMMARY

Implementations of the present disclosure are directed to modeling and evaluating models of facilities. More particularly, implementations of the present disclosure are directed to a facility design platform for automated modeling of facilities and generation of topological maps based on dynamic material workflows through facilities in generative design. In some implementations, and as described in further detail herein, the facility design platform of the present disclosure receives process requirements and design assumptions as input to automatically generate topological maps representative of respective facility designs during a generative design process. Each topological map can be used for material flow evaluation, for example. The design platform quickly and efficiently provides multiple facility design options and transparent explanations into projected facility cost, material flow, and the like.

In some implementations, actions include providing, within a facility design platform, a set of parameters, generating, by a layout generation module of the facility design platform, a set of zones at least partially based on the set of parameters, each zone associated with a set of tasks to be performed therein based on a material flow through the facility during execution of a process, for each zone in the set of zones, automatically generating a zone topological map defined as a zone graph including a set of nodes and a set of edges, the set of nodes including a set of area nodes and a set of terminal nodes, each area node representing a path that can be traveled along within the facility, each terminal node representing locations of the facility where at least one task is performed and is temporarily occupied during execution of the process, and merging, by the layout generation module, two or more zone topological maps to provide a facility topological map that models space, through which mobile agents traverse the facility and within which the mobile agents execute one or more tasks, merging at least partially including connecting at least one node of a first zone topological map with at least one node of a second zone topological map by an edge. Other implementations of this aspect include corresponding systems, apparatus, and computer programs, configured to perform the actions of the methods, encoded on computer storage devices.

These and other implementations can each optionally include one or more of the following features: merging includes moving a node of at least one zone topological map; the node is moved laterally along an edge of the at least one zone; the node is moved outward with respect to an interior of the at least one zone; each zone topological map includes at least one node that is fixed from movement during merging; merging at least partially includes inserting at least one dummy node between the first zone topological map with and the second zone topological map; merging at least partially includes clustering nodes of the first zone topological map and the second zone topological map as clustered nodes and replacing the clustered nodes with a single node; generating a zone topological map at least partially includes placing one or more objects within a zone, each object having at least one node associated therewith; each object is selected from a library of objects and represents at least one tasks and at least a portion of the material flow; and each node is associated with a set of node properties that represents properties of a space modeled by the respective node.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts an example system that can execute implementations of the present disclosure.

FIG. 2 depicts a block diagram of a facility design platform for execution of a generative design process in accordance with implementations of the present disclosure.

FIG. 3 depicts a representation of an example facility referenced for non-limiting illustrations of implementations of the present disclosure.

FIG. 4 depicts an example of zone topological map creation for a zone of a facility in accordance with implementations of the present disclosure.

FIG. 5 depicts an example of merging of zone topological maps to provide a facility topological map in accordance with implementations of the present disclosure.

FIGS. 6A-6E depict example techniques for merging of zone topological maps to provide a facility topological map in accordance with implementations of the present disclosure.

FIG. 7 depicts an example simulation using a facility topological map.

FIG. 8 depicts an example process in accordance with implementations of the present disclosure.

Like reference numbers and designations in the various drawings indicate like elements.

### DETAILED DESCRIPTION

Implementations of the present disclosure are directed to modeling and evaluating models of facilities. More particularly, implementations of the present disclosure are directed to a facility design platform for automated modeling of facilities and generation of topological maps based on dynamic material workflows through facilities in generative design. In some implementations, and as described in further detail herein, the facility design platform of the present disclosure receives process requirements and design assumptions as input to automatically generate topological maps representative of respective facility designs during a generative design process. Each topological map can be used for material flow evaluation, for example. The design platform quickly and efficiently provides multiple facility design options and transparent explanations into projected facility cost, material flow, and the like.

In some implementations, actions include providing, within a facility design platform, a set of parameters, generating, by a layout generation module of the facility design platform, a set of zones at least partially based on the set of parameters, each zone associated with a set of tasks to be performed therein based on a material flow through the facility during execution of a process, for each zone in the set of zones, automatically generating a zone topological map defined as a zone graph including a set of nodes and a set of edges, the set of nodes including a set of area nodes and a set of terminal nodes, each area node representing a path that can be traveled along within the facility, each terminal node representing locations of the facility where at least one task is performed and is temporarily occupied during execution of the process, and merging, by the layout generation module, two or more zone topological maps to provide a facility topological map that models space, through which mobile agents traverse the facility and within which the mobile agents execute one or more tasks, merging at least partially including connecting at least one node of a first zone topological map with at least one node of a second zone topological map by an edge.

Implementations of the present disclosure are described in further detail with reference to an example facility. The example facility includes a warehouse (e.g., functioning as a fulfillment center) having dynamic elements (e.g., workers, vehicles, robots) operating therein. It is contemplated, however, that implementations of the present disclosure can be realized for the design and evaluation of any appropriate type of dynamic facility.

To provide context for implementations of the present disclosure, and as introduced above, enterprises conduct operations to provide goods and services to customers. Enterprise operations are often conducted within and/or between facilities. Example facilities can include factories, warehouses, and distribution centers. Some facilities include elements that are dynamic (e.g., location changes over time). An example dynamic facility can include a warehouse with mobile agents (e.g., workers, vehicles, mobile robots). Some facilities are partially or fully automated.

The design of facilities can significantly impact multiple aspects of enterprise operations. Example aspects can include efficiency, cost, scalability, capacity, and flexibility. In view of this, approaches for facility design often seek to optimize one or more aspects. An increasingly popular design approach includes generative design, which can be described as a design exploration process that explores multiple design options based on an initial design goal and requirements.

The design process can be supported using computer-implemented tools, such as computer-aided design (CAD) programs. Example design tools include AutoCAD (provided by Autodesk, Inc.) and Tecnomatix (provided by Siemens AG). However, design tools can have limitations. For example, in terms of facility design, traditional design tools tend to focus on a particular industry, such as manufacturing. As another example, generative design tools provide functionality for design of static environments (e.g., offices, homes), there is an absence of functionality for dynamic environments. For example, traditional design tools that support generative design are limited to mechanical design and architecture. Traditional generative design tools are absent functionality for resource-efficiently and effectively modeling dynamic facilities that have mobile agents and dynamic flow of material.

While manual approaches have been used, such manual approaches are limited by the knowledge and experience of the particular designer executing the manual design process. Further, manual design processes limit the number of alternative designs, because each design requires time of the designer. Further, manual design processes require estimates and simplifying assumptions, which results in reduced accuracy of the resulting designs.

In view of this, implementations of the present disclosure provide a facility design platform for resource-efficient generation of multiple facility designs in a generative design process. More particularly, and as described in further detail herein, the facility design platform executes automated modeling to provide a zone topological map for each zone of a plurality of zones within the to-be-designed facility and merges the zone topological maps to provide a facility topological map. In a generative design process, a set of facility designs are automatically provided, each facility design being represented by a respective facility topological map. Each facility topological map models execution of a process (e.g., a delivery fulfillment process) through the zones based on material flow (e.g., movement of packages) within and between zones. In some implementations, each facility topological map is used in a simulation to evaluate performance of the respective facility design with respect to one or more aspects.

As described in further detail herein, implementations of the present disclosure provide a set of zone topological maps and a facility topological map. The facility topological map is generated by merging two or more zone topological maps using one or more merging techniques. In accordance with implementations of the present disclosure, each topological map (e.g., zone topological map, facility topological map) is defined by a set of nodes and a set of edges, each edge connected nodes in the set of nodes. Each node in the set of nodes can be of a respective type of node. Example types of nodes include, without limitation, area nodes and terminal nodes. In some examples, an area node represents an area of the facility that an agent (e.g., worker, mobile robot) can traverse within the facility. That is, an area node represents a path that can be traveled along within the facility (e.g., an aisle between physical objects). In some examples, a terminal node represents locations of the facility where a task is performed by an agent (e.g., worker, mobile robot), and is, hence, at least temporarily occupied (e.g., occupied for the duration of the task), but can be traversed when the task is not being performed. That is, a terminal node represents a location that is intermittently, temporarily occupied (e.g., while an agent is performing a task), but can be traveled through when unoccupied. In some examples, each edge models a path that an agent can travel along between nodes.

In some implementations, each node includes a set of node properties that model a physical space within a facility. Example node properties can include, without limitation, dimensions of the space, shape of the space, a type of space (e.g., aisle, intersection, task performance), types of agents that are expected to (temporarily) occupy the space, expected time of occupation (e.g., average duration of occupation for each type of agent), and the like. In some examples, node properties for area nodes are different than node properties for terminal nodes. For example, for area nodes, the set of node properties may be absent expected time of occupation, because a task is not preformed within spaces modeled by area nodes. Instead, a time of occupancy can be modeled based on, for example, a size of a space and a speed of an agent that is to pass therethrough (e.g., length of an aisle divided by a velocity of a mobile agent passing therethrough to determine a duration of time that the mobile agent is in the aisle). As another example, for area nodes, the set of node properties can include direction of travel (e.g., one-way, two-way, four-way for intersections). As another example, for terminal nodes, the set of node properties can include one or more tasks to be performed within the space model by a terminal node for each of one or more agents. For example, the set of properties can indicate a set of tasks (e.g., picking one or more items from a shelf, stocking a shelf with one or more items, retrieving one or more items for stocking, dropping one or more items off for packing) to be performed by a mobile robot and an expected time to perform each task (e.g., X seconds to pick one or more items from a shelf, Y second to stock a shelf with one or more items).

As described herein, the set of nodes of a topological model, and hence, the topological model itself, models space within the facility, which can be temporarily occupied. That is, the topological model models space (an absence of permanently placed physical objects) as opposed to physical objects (e.g., shelves, tables, walls, doors, windows) that define or are otherwise located within the facility. In this manner, the topological models model how agents, such as mobile robots, traverse through the facility and commute through particular spaces. This provides multiple technical advantages. An example technical advantage includes a relatively small size of a computer-readable file that stores data representative of the facility topological map (and/or each zone topological map). For example, multi-dimensional CAD models of facilities can be hundreds to thousands of megabytes (MB) or even gigabytes (MB), some potentially being terabytes (TB) in size. A facility topological model of the present disclosure can be significantly smaller (e.g., KBs to low MBs) for modeling the same facility as a multi-dimensional CAD model. In this manner, the facility topological maps of the present disclosure occupy a smaller memory footprint and, as such, more facility topological maps can be stored (e.g., facility topological maps representing respective versions of a facility). Further, computing resources (e.g., processors, memory) expended to generate a facility topological map is significantly lower than those expended to generate other types of models, such as multi-dimensional CAD models. In this manner, less powerful computing devices can be used to provide facility topological map and/or one or more facility topological maps can be generated more quickly. Further, another technological advantage includes technical efficiencies achieved during simulations. That is, for example, simulations that are based on facility topological maps of the present disclosure are more time- and resource-efficient than simulations based on other types of models, such as multi-dimensional CAD models.

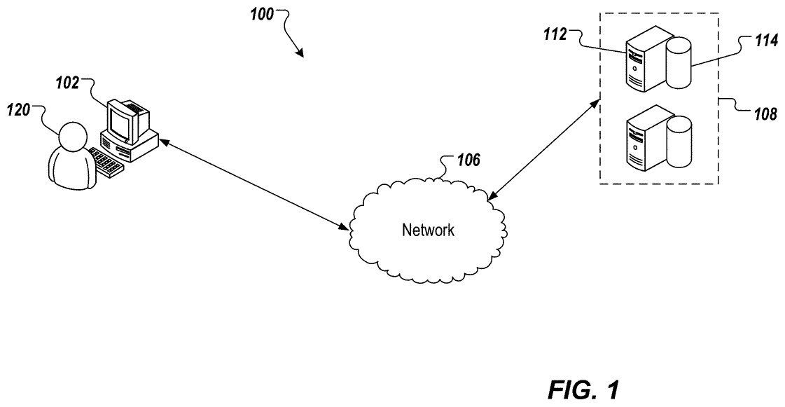

FIG. 1 depicts an example system 100 that can execute implementations of the present disclosure. The example system 100 includes a computing device 102, a back-end system 108, and a network 106. In some examples, the network 106 includes a local area network (LAN), wide area network (WAN), the Internet, or a combination thereof, and connects web sites, devices (e.g., the computing device 102), and back-end systems (e.g., the back-end system 108). In some examples, the network 106 can be accessed over a wired and/or a wireless communications link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In the depicted example, the back-end system 108 includes at least one server system 112, and data store 114 (e.g., database). In some examples, the at least one server system 112 hosts one or more computer-implemented services that users can interact with using computing devices.

In some implementations, the back-end system 108 hosts a facility design platform in accordance with implementations of the present disclosure. In some examples, a user 120 (e.g., a designer) can interact with the facility design platform using the computing device 102. For example, the computing device 102 can provide one or more user interfaces (UIs) (e.g., graphical user interfaces (GUIs)) to enable the user 120 to provide input to and receive output from the facility design platform. For example, a session can be established between the computing device 102 and the facility design platform hosted in the back-end system 108, and, during the session, data is transmitted between the computing device 102 and the facility design platform.

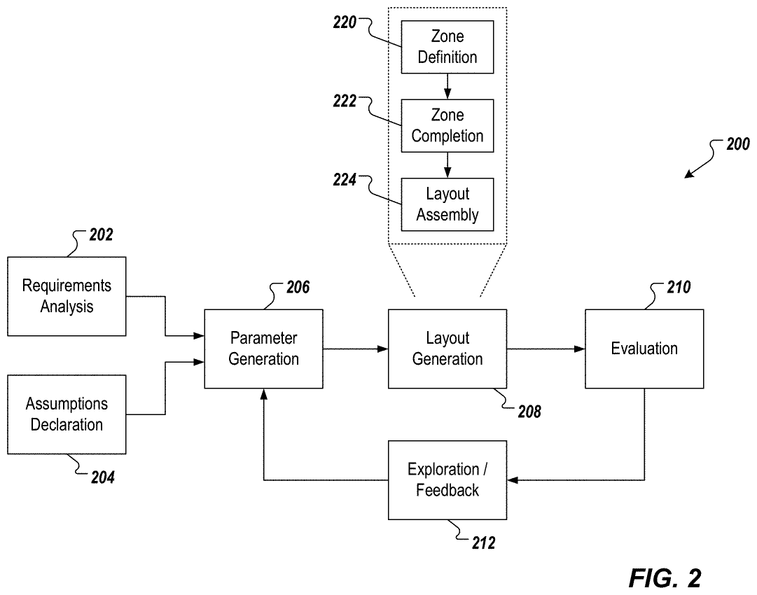

FIG. 2 depicts a block diagram of a facility design platform 200 for execution of a generative design process in accordance with implementations of the present disclosure. In the example of FIG. 2, the facility design platform 200 includes a requirements analysis module 202, an assumptions declaration module 204, a parameter generation module 206, a layout generation module 208, an evaluation module 210, and an exploration/feedback module 212. In some examples, the requirements analysis module 202, the assumptions declaration module 204, the parameter generation module 206, the layout generation module 208, the evaluation module 210, and the exploration/feedback module 212 can each be encoded in a respective computer-executable program (e.g., each executed in the back-end system 108 of FIG. 1). In some examples, the requirements analysis module 202, the assumptions declaration module 204, the parameter generation module 206, the layout generation module 208, the evaluation module 210, and the exploration/feedback module 212 can be collectively encoded in a computer-executable program (e.g., executed in the back-end system 108 of FIG. 1).

In some implementations, the requirements analysis module 202 receives a set of requirements (e.g., data representative of a set of requirements). For example, the set of requirements can be provided by a designer (e.g., the user 120 of FIG. 1). In some examples, the set of requirements includes one or more requirements that each facility design is to meet. Example requirements can include, without limitation, the facility being a fulfillment center, dimensions of the facility (e.g., size and/or size range of the facility), a shape of the facility (e.g., perimeter geometry), zones (e.g., zone for loading in items by pallets, zone for stocking items on shelves/picking items from shelves, zone for packing items by orders, and zone for shipping items out in pallets). Another example requirement can include the use of mobile agents (e.g., mobile robots) to handle material movement within the facility. It is contemplated that facilities of different types can have different requirements. For example, and in the example context of a manufacturing facility, example requirements can include manufacturing line configuration and components, details on the type/size/weight of goods at each stage, automatic selection of automated guided vehicles (AGVs)/autonomous mobile robots (AMRs), and layout of the overall factory/manufacturing lines and/or cells. Other example requirements can include the budget of the facility (e.g., total cost to build the facility and average cost of daily operation), the capacity of the facility (e.g., number of the items to store in the facility), and business and/or safety standards (e.g., minimum length of an aisle, locations of exits).

In some implementations, the assumption declaration module 204 receives a set of assumptions (e.g., data representative of a set of assumptions). For example, the set of assumptions can be provided by a designer (e.g., the user 120 of FIG. 1). In some examples, the set of assumptions includes one or more assumptions that each facility design is to consider. Example assumptions can include, without limitation, expected tasks (e.g., unloading, stocking, picking, packing, shipping), size of each type of equipment, worker rate for each task, task time, estimated volume, speed of mobile robots, working hours per day, task schedule/distribution, and congestion bands (e.g., the amount of interference between robots).

In some implementations, the parameter generation module 206 receives the set of requirements and the set of assumptions, and processes each to generate a set of parameters (e.g., data representative of a set of parameters). In some examples, parameters in the set of parameters include layout parameters representative of one or more processes and flow(s) of material through respective processes. Example parameters include, without limitation, a process that is to be executed in the facility (e.g., a series of tasks that are to be performed), an estimated cost rate of each process, an area of the facility (e.g., square footage), and the like. With non-limiting reference to the example facility introduced above (i.e., a warehouse), example parameters can also include, without limitation, a minimum number of storage shelves, a minimum number of packing tables, a number of loading docks, a number of mobile robots, a number of charging stations (e.g., to charge the moving robots), a storage aisle size, a price of each mobile robot, and a size and price of storage shelf, packing table, docks, and charging stations.

In further detail, the parameter generation module 206 is responsible for creating a variety of different scenarios to run. For example, facility design can be evaluated using multiple starting points or sets of assumptions (e.g., how does the site perform if the robots are slightly faster/slower, the site is slightly larger/smaller). The initial guesses for many of these parameters are created based on industry best practices and data from previous facilities and the parameter generation module 206 generates multiple versions of these parameters to be evaluated. An example relationship that can be used to determine example parameters (minimum number of storage shelves, cost rate per process) is provided as:

$$minimum number of storage shelf = \frac{item storage capacity in facility ( requirement )}{items per shelf ( assumption )}$$

cost rate per process=worker rate per hour*average hours per process(assumption)

In some implementations, the layout generation module 208 receives the set of parameters and generates one or more facility designs based on the set of parameters. In the example of FIG. 2, the layout generation module 208 includes a zone definition sub-module 220, a zone completion sub-module 222, and a layout assembly sub-module 224. In some examples, the zone definition sub-module 220 receives the set of parameters as input and defines a set of zones that are to be included in the facility design. In some examples, each zone is defined as a set of zone parameters (e.g., a zone dataset), which can include, without limitation, zone size, zone dimensions, static element(s) to be located in the zone, a number of each static element, dimensions of each static element, dynamic element(s) intermittently located in the zone, a number of each dynamic element, dimensions of each dynamic element, and the like. In some examples, shapes of respective zones can be reviewed to determine whether the shapes are cohesive with respect to the overall facility parameters (e.g., size, shape). For example, it can be determined that the zones are not cohesive, if zones impinge upon one another within the facility footprint, and/or if one or more zones extends beyond the facility footprint. If zones are determined not to be cohesive, the zones can be re-defined and cohesiveness again checked. In some examples, whether zones are cohesive include determining whether there are intersecting edges between the different zones. If two edges intersect, there is overlap between the zones.

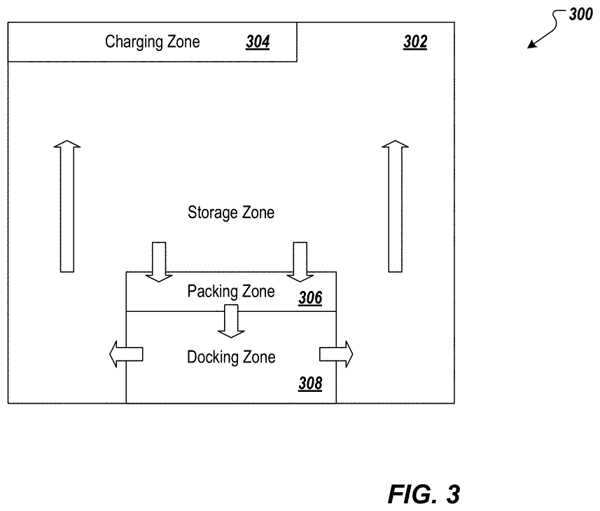

With non-limiting reference to the example facility introduced above (i.e., a warehouse), example zones include a storage zone, a charging zone, a packing zone, and a docking zone. FIG. 3 depicts a representation 300 of the example facility referenced for non-limiting illustrations of implementations of the present disclosure. The example facility includes a warehouse that is to have dynamic elements, such as mobile robots. In the example of FIG. 3, the facility includes a storage zone 302, a charging zone 304, a packing zone 306, and a docking zone 308. In some examples, geometries of each of the zones within the facility can be defined in the set of parameters.

In some examples, a process that is to be executed in the facility (e.g., a series of tasks that are to be performed) is provided in the set of parameters. In some examples, the process represents material flow (e.g., movement of packages) within a zone and/or between zones. Example material flows are depicted as arrows in the example of FIG. 3. An example process and implicated material flow through the facility represented in FIG. 3 is provided as:

TABLE 1
Example Process and Material Flow

| Material | | |
|---|---|---|
| Flow Step | Zone | Process Task(s) |
| 1 | Docking | Pallets of items arrive at the warehouse |
| | | loading docks. |
| 2 | Storage | Mobile agents pick items from dock and |
| | | move items to storage shelves. |
| 3 | Storage | In response to order requests, mobile |
| | | agents pick items from shelves and place |
| | | items on the packing table. |
| 4 | Packing | Items are packed by order on packing table |
| | | and placed on pallets. |
| 5 | Docking | Mobile agents deliver pallets to docks for |
| | | shipping. |
| 6 | Docking | Pallets shipped from warehouse. |

Referring again to FIG. 2, the zone completion sub-module 222 processes at least a portion of the set of parameters and the set of zones to provide a zone topological map for each zone in the set of zones. As described in further detail herein, each zone topological map is defined as a set of nodes and edges between nodes. In some examples, each node is assigned as a type of node. Example types of nodes include, without limitation, area nodes and terminal nodes. In some examples, an area node represents an area of the facility that an agent (e.g., worker, mobile robot) can traverse within the facility. In some examples, a terminal node represents locations of the facility where a task is performed by an agent (e.g., worker, mobile robot), and is, hence, at least temporarily occupied (e.g., occupied for the duration of the task), but can be traversed when the task is not being performed.

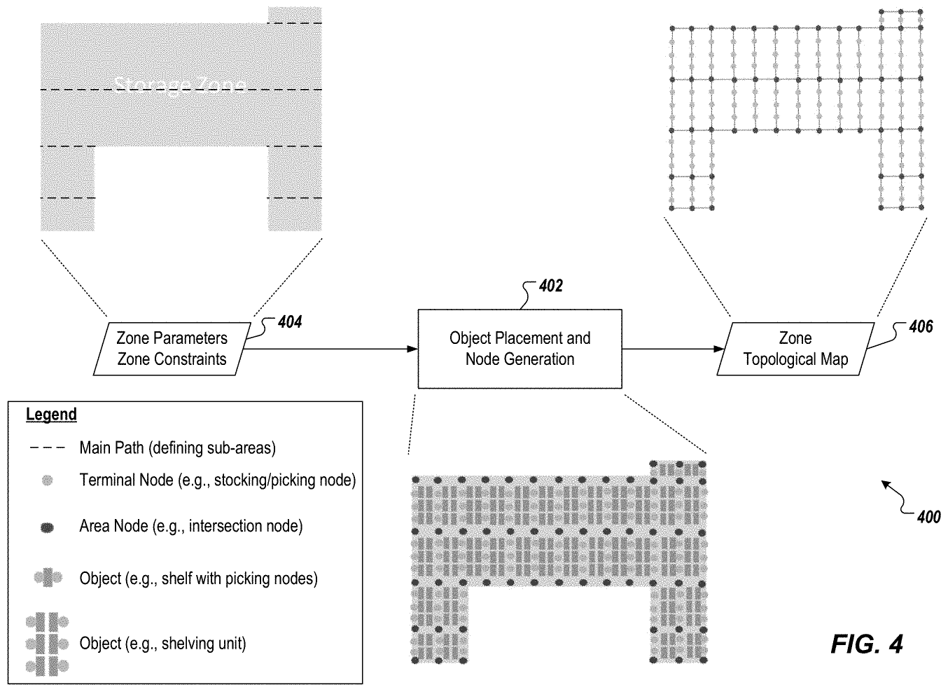

FIG. 4 depicts an example of zone topological map creation 400 for a zone of a facility in accordance with implementations of the present disclosure. The example of FIG. 4 includes a storage zone. In general, the storage zone can be described as an area for stocking items on storage shelves, where items unloaded from a docking zone will be stored to await retrieval by mobile agents. In some examples, an object placement and node generation module 402 (e.g., provided within the zone completion sub-module 222 of FIG. 2) processes a set of zone parameters and a set of zone constraints 404 to provide a zone topological map 406. In the example of a storage zone, the set of zone parameters can include, without limitation, a size of the zone (e.g., square footage), dimensions of the zone (e.g., width, length), layout shape, item stock volume, shelf size, shelf price, aisle width, aisle length, and number of aisle breaks. In the example of a storage zone, the set of zone constraints can include, without limitation, storage zone must have enough shelves to hold the assumed stock volume, and all items on shelves should be reachable by a mobile agent (e.g., sufficient space between objects).

While implementations for zone topological map generation are described in detail herein with non-limiting reference to a storage zone, it is contemplated that zone topological maps can be generated for any appropriate zones. Other example zones include, as introduced above, a docking zone and a packing zone. In some examples, a docking zone can be described as an area that provides docks and space for operations that unload pallets delivered to the facility and ship pallets out of the facility. In the example of a docking zone, the set of zone parameters can include, without limitation, minimum number of docks, dock size, dock price, and minimum distance between docks. In the example of a docking zone, the set of zone constraints can include, without limitation, a number of docks required to handle daily operations, and each dock must be accessed by a truck from one side and another zone from another side. In some examples, a packing zone can be described as an area that contains packing tables for packing of items for shipment. For example, each item that is picked by a mobile robot will be placed on a packing table and packed (e.g., together with other items) by order. The packed orders are moved to a pallet for shipping. In the example of a packing zone, the set of zone parameters can include, without limitation, a minimum number of packing tables, packing table size, packing table price, table extension area, packing zone dimensions (e.g., width, length). In the example of a packing zone, the set of zone constraints can include, without limitation, packing zone to be located next to docking zone, and packing zone size should be big enough to hold at least the required number of packing tables.

With continued reference to FIG. 4, in generating the zone topological map 406, the object placement and node generation module 402 references an object library, which provides objects that can be located within zones. For example, and in the case of a storage zone, the set of parameters can indicate that shelving units (i.e., objects) are to be located within the storage zone and one or more shelving unit objects can be retrieved from the object library. As another example, and in the case of a packing zone, the set of parameters can indicate that packing tables (i.e., objects) are to be located within the storage zone and one or more packing table unit objects can be retrieved from the object library.

As depicted in the example of FIG. 4, a set of objects can include a single shelf (object) and a shelving unit (object). In some examples, each object is associated with one or more nodes. For example, the single shelf is associated with a terminal node disposed on respective sides, each terminal node representing a location of a task that can be performed (e.g., stocking the single shelf with an item, picking an item from the single shelf). As another example, the shelving unit includes shelves positioned adjacent to one another and each shelf associated with a terminal node representing a location of a task that can be performed (e.g., stocking the shelf with an item, picking an item from the shelf). In this example, when multiple shelves are too close together to make an aisle (e.g., shelves put together to form a shelving unit), the shelves only can only be accessed from one side, thus the terminal node from the blocked side is removed.

In accordance with implementations of the present disclosure, each object (with attached nodes and edges) functions as a building block and point of alignment that enable the interior of the zone to be populated. In some examples, spacing between objects is populated with area nodes. In some examples, the spacing can be adjusted with parameters (e.g., aisle width). More particularly, the object placement and node generation module 404 takes a divide and conquer approach in populating the zone with objects, which includes, based on the zone's function and constraints, heuristically placing main paths into the zone (see example of FIG. 4), and using the main paths to divide the zone into sub-areas.

The object placement and node generation module 402 executes placement of objects within a sub-area as a bin packing problem. In general, a bin packing problem can be described as objects of different volumes to be packed into a finite number of bins (or containers), each bin having a fixed and given volume, where the objects are to be packed in a way that minimizes the number of bins used. In some implementations, each sub-area is considered a bin in the bin packing problem. In some implementations, a third-party bin packing tool can be used for placement of objects within a sub-area. An example third-party tool includes, without limitation, OR-Tools provided by Google. In some examples, spaces between objects are populated with area nodes (i.e., intersections between objects). For example, each main path can be populated with area nodes, as depicted in the example of FIG. 4.

In some implementations, the object placement and node generation module 402 checks placement of objects relative to adjacent zones. For example, it can occur that objects in different zones are too close to each other and block the paths. That is, it can be determined that the placement of an object in a zone at least partially blocks a path that is disposed between the zone and another zone. In response, the object placement and node generation module 402 can adjust a position of the object within the zone, for example. In another example, in response, the object placement and node generation module 402 can re-execute placement of objects within the zone and/or the adjacent zone.

After the zone has been populated with objects, edges are provided between nodes. In some examples, edges are provided between adjacent notes that are unobstructed from each other. For example, in the case of a shelving unit, an edge is provided between adjacent terminal nodes, adjacent terminal node and area node, and adjacent area nodes. However, in the case of a shelving unit, terminal nodes on opposite sides of the shelving unit do not have an edge provided therebetween, because the shelving unit obstructs the terminal nodes. In this manner, the zone topological map 406 is provided. Although the zone topological map 406 is graphically depicted as a mesh of nodes and edges, it is contemplated that the zone topological map 406 is represented in a zone topological map (ZTM) data set, which includes data representing each node (e.g., type, location, unique identifier) and edges between nodes (e.g., defined in terms of node pairs connected by an edge).

Referring again to FIG. 2, the layout assembly sub-module 224 processes the zone topological maps provided from the zone completion sub-module 222 to provide a facility topological map. More particularly, and as described in further detail herein, multiple zone topological maps are merged to provide the facility topological map.

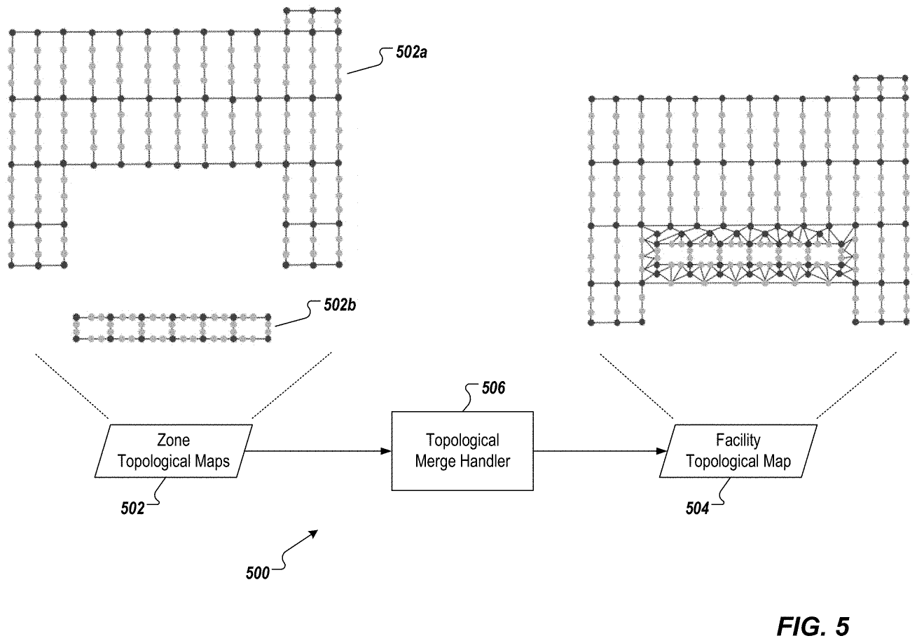

FIG. 5 depicts an example of merging 500 of zone topological maps 502 to provide a facility topological map 504 in accordance with implementations of the present disclosure. More particularly, and as described in further detail herein, a topological merge handler 506 (e.g., provided within the layout assembly sub-module 224 of FIG. 2) merges the multiple zone topological maps using one or more merge techniques. In the example of FIG. 5, a storage zone topological map 502a is merged with a packing zone topological map 502b to provide the facility topological map 504.

In further detail, merging of the zone topological maps includes enforcing adjacency between zones by the material flow, and adjusting zone edges based on a requirement (e.g., an aisle between zones). In some examples, a relative location of each object is converted a universal location. that is, relative coordinates are converted to universal coordinates.

In some implementations, the output of the topological merge handler 506 checks the current scenario (e.g., which zones are being merged) and associated constraints, and uses one or more merging techniques to merge the zone topological maps. Example constraints can include, without limitation, certain aisles cannot be adjusted such that nodes along the aisle cannot be removed or changed, a particular node can only be moved laterally or outward relative to an interior of a zone, a particular node can only be moved outward relative to an interior of a zone. In general, the topological merge handler 506 handles different types of merge cases that can occur. Example merge cases can include, without limitation, nodes from different zones are too close to each other (redundant to keep both), different types of nodes from different zones overlay each other, redundant paths between zones, and empty space between zones. Example merging techniques can include, without limitation, combining multiple nodes into a single node, moving nodes, inserting dummy nodes, adding paths to exterior nodes, and adding paths to exterior nodes and generating a minimum spanning tree as a disjoint sets problem, as discussed in further detail herein. In some implementations, if a merge conflict exists that cannot be handled by the topological merge handler 506 using one or more of the merge techniques, and alarm can be triggered and a message can be provided with relevant information for manual intervention (e.g., a designer manually merges at least a portion of the zones using a UI).

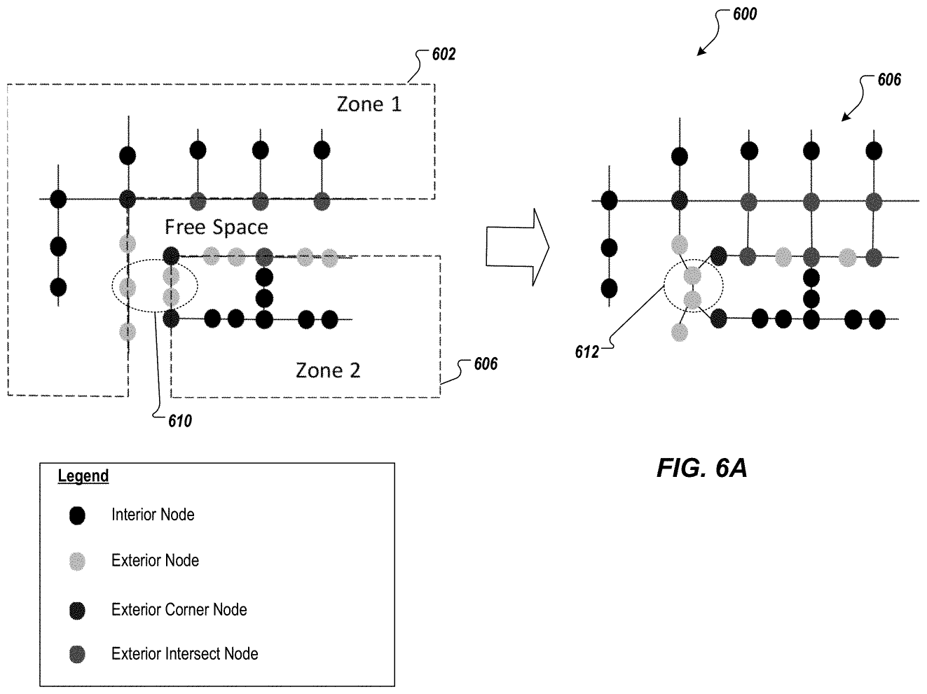

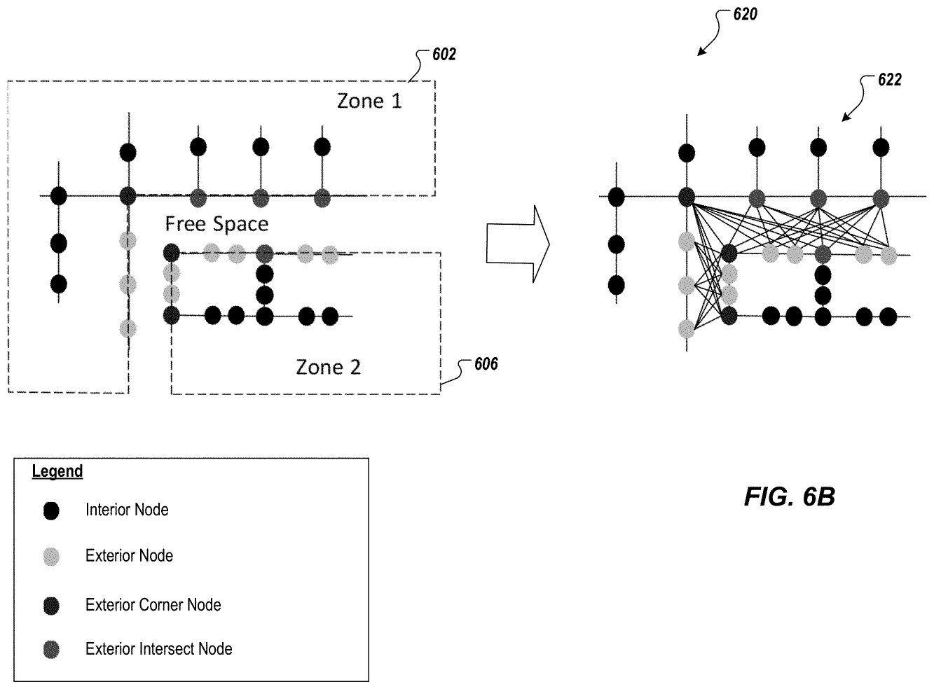

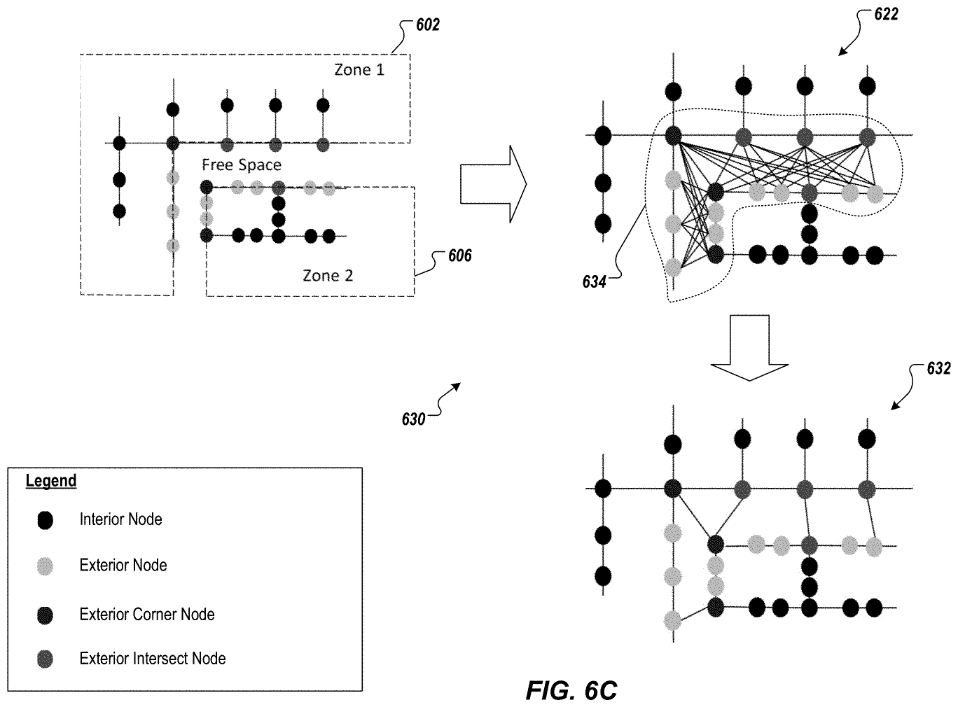

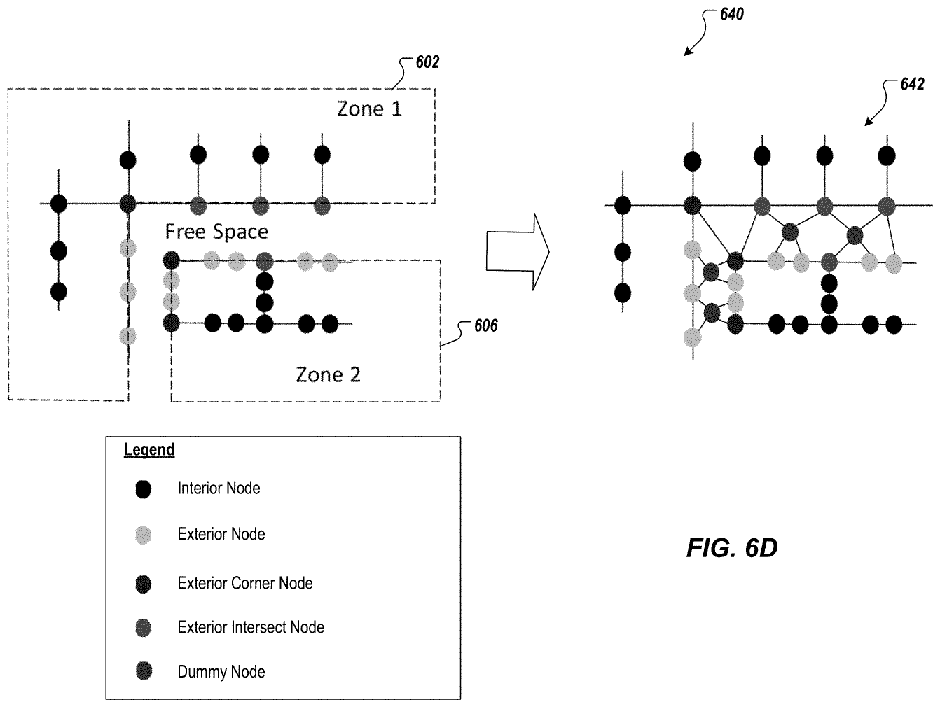

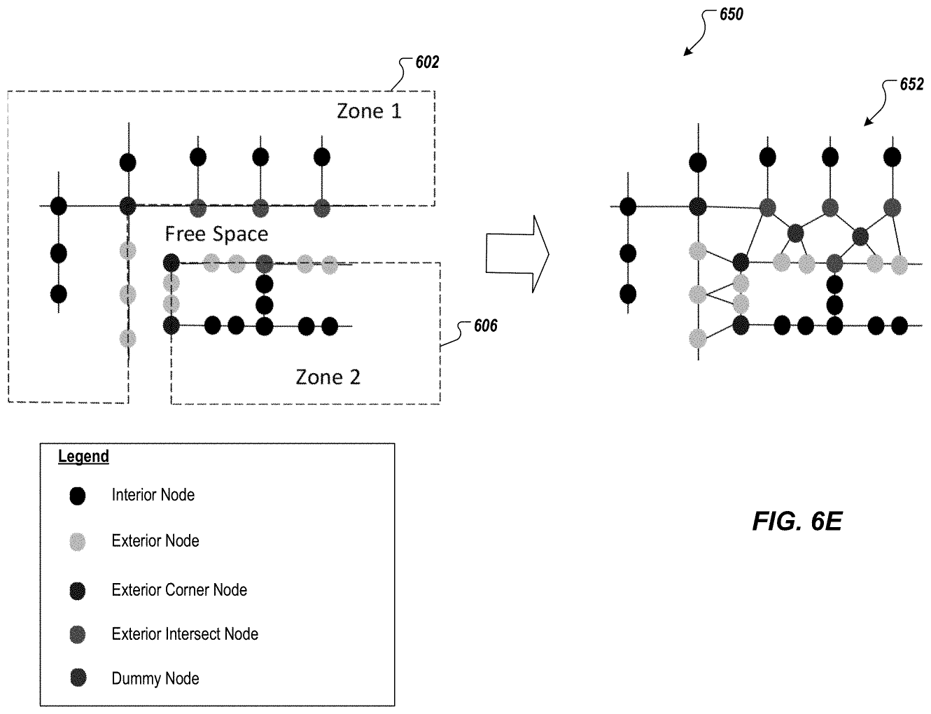

FIGS. 6A-6E depict example techniques for merging of zone topological maps to provide a facility topological map in accordance with implementations of the present disclosure. In some implementations, and as described in further detail herein, one or more nodes of a zone topological map can be assigned a sub-type of node for merging. Example sub-types of nodes include interior nodes, exterior nodes, exterior corner nodes, and exterior intersect nodes. Each sub-type of node having one or more merge properties. In some examples, interior nodes include nodes (e.g., area nodes, terminal nodes) that are located within an interior of a zone. In some examples, a merge property of interior nodes is that interior nodes are static (immovable). In some examples, exterior nodes include nodes (e.g., area nodes, terminal nodes) that are located along a perimeter of a zone. In some examples, merge properties of exterior nodes include that exterior nodes can move laterally along the perimeter and/or outward from the zone. In some examples, exterior corner nodes include nodes (e.g., area nodes, terminal nodes) that are located at corners of a perimeter of a zone. In some examples, a merge property of exterior corner nodes is that exterior corner nodes are static (immovable). In some examples, exterior intersect nodes include nodes (e.g., area nodes, terminal nodes) that are located along a perimeter of a zone and are connected to at least one interior node by an edge. In some examples, merge properties of exterior intersect nodes include that exterior intersect nodes cannot move laterally along the perimeter and can move outward from the zone along an axis that is perpendicular to the perimeter.

FIG. 6A depicts an example of merging 600 of example portions of zone topological maps 602, 604 to provide a portion of a facility topological map 606 by adjusting positions of nodes and/or combining nodes. In some examples, positions of exterior nodes are adjusted to enable near-by nodes between zones 602, 604 to be clustered together and one or more nodes can be combined. In some examples, a clustering technique can be executed. Example clustering techniques can include, without limitation, k-means, agglomerative clustering, and spectral clustering. In some examples, two or more of the clustered nodes can be combined to a single node and/or multiple nodes representative of the cluster. In the example of FIG. 6A, a cluster of exterior nodes 610 is defined and results in moved and combined nodes 612 in the facility topological map 606. In some examples, exterior intersect nodes are able to extend the current zone to the nearest part of another zone. If the nearest point of the zone is an edge, a new intersect node is formed. To reduce the overall space complexity of the graph, nearby boundary nodes (non-intersect nodes) may merge with the new intersect node.

FIG. 6B depicts an example of merging 620 of example portions of zone topological maps 602, 604 to provide a portion of a facility topological map 622 by adding edges between exterior nodes of the zones. In some examples, this is achieved by, for each exterior node, exterior intersect node, and/or exterior corner node of the zone 602, an edge is provided to each exterior node, exterior intersect node, and/or exterior corner node of the zone 604 that has an unobstructed line-ofsight. That is, only edges between exterior (intersect/corner) nodes that do not intersect with a third node and/or pass through an interior of a zone are added. That is, each edge is in free space only. If a path between zones must pass through an occupied area (e.g., node, zone interior), the edge is not added.

FIG. 6C depicts an example of merging 630 of example portions of zone topological maps 602, 604 to provide a portion of a facility topological map 632 by adding edges between exterior nodes of the zones and reducing the edges by solving a disjoint sets problem. In some examples, all exterior nodes are defined as a graph node set including edges that are provided between nodes, as discussed above with reference to FIG. 6B. In some examples, edges are removed by based on a minimum spanning tree. For example, the graph node set can be processed using an appropriate technique to generate the minimum spanning tree. Example techniques include, without limitation, Kruskal's algorithm, Prim's algorithm, or any appropriate minimum spanning tree algorithms. In general, an undirected and connected graph (G=(V, E), where V is a set of vertices (nodes) and E is a set of edges between vertices) is provided and includes the exterior nodes of zones and edges between the exterior nodes between zones (e.g., sets of nodes and sets of vertices 634 from the facility topological map 622). The connected graph is processed to define two or more spanning trees of the graph G is a tree that spans the graph G (that is, it includes every vertex of the graph G) and is a sub-graph of the graph G (every edge in the tree belongs to the graph G). A cost of each spanning tree is determined (e.g., by summing weights of all edges in the spanning tree), and the minimum spanning tree is the spanning tree having the minimum cost. In some examples, the weight is provided based on a length of the edge or the traversal difficulty of the edge. The traversal difficulty may factor in the width of the aisle, average speed of travel, and the like, as well as the length.

FIG. 6D depicts an example of merging 640 of example portions of zone topological maps 602, 604 to provide a portion of a facility topological map 642 by adding dummy nodes between the zones. In some examples, dummy nodes are added in the free space between zones. In some examples, the number and location of the dummy nodes is determined based on the size of the free space. Each dummy node is connected with nearby exterior nodes of each zone. In some examples, the dummy nodes are placed in the center of the free space between the zones. Each dummy node is connected with nearby exterior nodes of each zone. The locations of the dummy nodes are dynamically adjusted for shorter paths between the zones.

FIG. 6E depicts an example of merging 650 of example portions of zone topological maps 602, 604 to provide a portion of a facility topological map 652 by combining two or more margining techniques of FIGS. 6A-6D. In some examples, dummy nodes are added between zones based on the size and shape of the free space between zones, and material flow requirement through the free space (e.g., as discussed above with respect to FIG. 6D). Edges between exterior nodes across zones and between exterior nodes and dummy nodes based on a minimum spanning tree (e.g., as discussed above with respect to FIG. 6C). In some examples, edges are added into the free space to increase throughput between zones. In some examples, unnecessary edges are removed. In some examples, edges that overlap would be removed or broken down into multiple edges with a shared node. Generally, removing edges is avoided and, instead, the number of edges is limited to limit the computational load of determining optimal paths.

Referring again to FIG. 2, in some implementations, the layout generation module 208 provides at least one facility topological map as output to the evaluation module 210. In some examples, the facility topological map (e.g., the facility topological map 504 of FIG. 5) is represented in a facility topological map (FTM) data set, which includes data representing each node (e.g., type, location, unique identifier) and edges between nodes (e.g., defined in terms of node pairs connected by an edge). The evaluation module 210 executes one or more simulations using the facility topological map. Example simulation is described in detail in commonly assigned U.S. Prov. App. No. 63/021,877, filed on May 8, 2020 and entitled Enhanced Robot Fleet Navigation and Sequencing, the disclosure of which is expressly incorporated herein by reference in the entirety for all purposes.

In some examples, each simulation enables an overall score of a facility based on a combination of the cost of the facility installation, daily operation, and material throughput, among other characteristics. In some examples, each simulation simulates daily picking operations on one or more mobile robots, which can include, among other tasks, stocking shelves and picking items from shelves. In some examples, an average time per pick/stock can be determined and the monetary costs of picks/stocks can be calculated. In some examples, the daily operational cost for the facility can be determined at least partially based on cost of operations executed in related zones. Further, the installation and material costs of the facility can be determined. An overall evaluation of the facility can be provided as least partially based on a sum of the various costs.

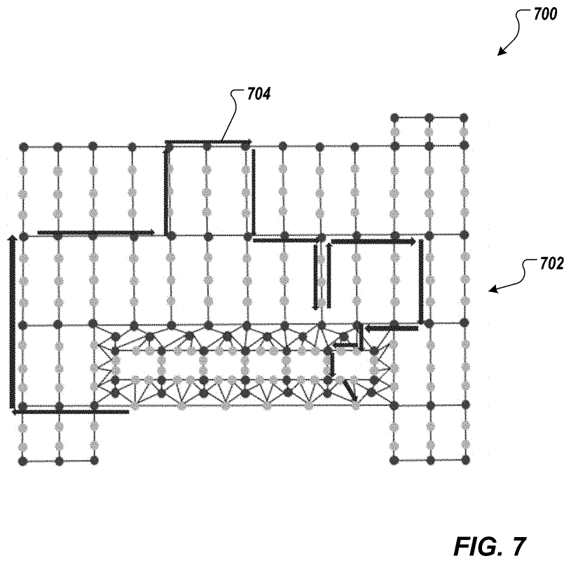

FIG. 7 depicts example simulation 700 using a facility topological map 702. The example simulation 700 of FIG. 7 depicts an example path 704 that a mobile robot can travel along during daily operations. Although the example simulation 700 depicts a single path for a single mobile robot, simulations can provide multiple paths for each mobile robot of multiple mobile robots.

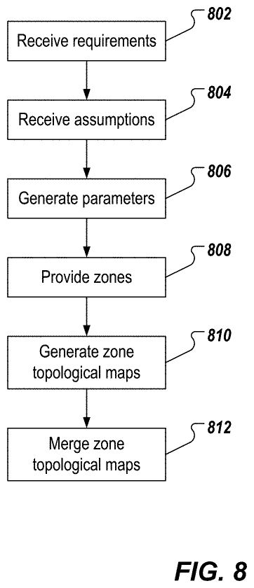

FIG. 8 depicts an example process 800 in accordance with implementations of the present disclosure. The example process 800 can be executed as one or more computer-executable programs.

A set of requirements is received (802) and a set of assumptions is received (804). For example, and as described herein, the parameter generation module 206 of the facility design platform 200 of FIG. 2 receives the set of requirements and the set of assumptions. A set of parameters is generated (806). For example, and as described herein, the parameter generation module 206 processes the set of requirements and the set of assumptions to generate a set of parameters (e.g., data representative of a set of parameters). In some examples, parameters in the set of parameters include layout parameters representative of one or more processes and flow(s) of material through respective processes.

A set of zones is defined (808). For example, and as described herein, the layout generation module 208 receives the set of parameters and generates one or more facility designs based on the set of parameters. More particularly, the zone definition sub-module 220 receives the set of parameters as input and defines a set of zones that are to be included in the facility design. In some examples, each zone is defined as a set of zone parameters (e.g., a zone dataset). A set of zone topological maps is generated (810). For example, and as described in detail herein, the zone completion sub-module 222 processes at least a portion of the set of parameters and the set of zones to provide a zone topological map for each zone in the set of zones. Zone topological maps are merged (812). For example, and as described in detail herein, the layout assembly sub-module 224 processes the zone topological maps provided from the zone completion sub-module 222 to provide a facility topological map. More particularly, multiple zone topological maps are merged to provide the facility topological map.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more th ereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for computer-based modeling of a facility as a facility topological map, comprising:
providing, within a facility design platform, a set of parameters;
generating, by a layout generation module of the facility design platform, a set of zones at least partially based on the set of parameters, each zone associated with a set of tasks to be performed therein based on a material flow through the facility during execution of a process;
for each zone in the set of zones, automatically generating a zone topological map defined as a zone graph comprising a set of nodes and a set of edges, the set of nodes comprising a set of area nodes and a set of terminal nodes, each area node representing a path that can be traveled along within the facility, each terminal node representing locations of the facility where at least one task is performed and is temporarily occupied during execution of the process; and
merging, by the layout generation module, two or more zone topological maps to provide a facility topological map that models space, through which mobile agents traverse the facility and within which the mobile agents execute one or more tasks, merging at least partially comprising connecting at least one node of a first zone topological map with at least one node of a second zone topological map by an edge.

2. The method of claim 1, wherein merging comprises moving a node of at least one zone topological map.

3. The method of claim 2, wherein the node is moved laterally along an edge of the at least one zone.

4. The method of claim 2, wherein the node is moved outward with respect to an interior of the at least one zone.

5. The method of claim 1, wherein each zone topological map comprises at least one node that is fixed from movement during merging.

6. The method of claim 1, wherein merging at least partially comprises inserting at least one dummy node between the first zone topological map with and the second zone topological map.

7. The method of claim 1, wherein merging at least partially comprises clustering nodes of the first zone topological map and the second zone topological map as clustered nodes and replacing the clustered nodes with a single node.

8. The method of claim 1, wherein generating a zone topological map at least partially comprises placing one or more objects within a zone, each object having at least one node associated therewith.

9. The method of claim 8, wherein each object is selected from a library of objects and represents at least one tasks and at least a portion of the material flow.

10. The method of claim 1, wherein each node is associated with a set of node properties that represents properties of a space modeled by the respective node.

11. One or more non-transitory computer-readable storage media coupled to one or more processors and having instructions stored thereon which, when executed by the one or more processors, cause the one or more processors to perform operations for computer-based modeling of a facility as a facility topological map, the operations comprising:
providing, within a facility design platform, a set of parameters;
generating, by a layout generation module of the facility design platform, a set of zones at least partially based on the set of parameters, each zone associated with a set of tasks to be performed therein based on a material flow through the facility during execution of a process;
for each zone in the set of zones, automatically generating a zone topological map defined as a zone graph comprising a set of nodes and a set of edges, the set of nodes comprising a set of area nodes and a set of terminal nodes, each area node representing a path that can be traveled along within the facility, each terminal node representing locations of the facility where at least one task is performed and is temporarily occupied during execution of the process; and
merging, by the layout generation module, two or more zone topological maps to provide a facility topological map that models space, through which mobile agents traverse the facility and within which the mobile agents execute one or more tasks, merging at least partially comprising connecting at least one node of a first zone topological map with at least one node of a second zone topological map by an edge.

12. The non-transitory computer-readable storage media of claim 11, wherein merging comprises moving a node of at least one zone topological map.

13. The non-transitory computer-readable storage media of claim 12, wherein the node is moved laterally along an edge of the at least one zone.

14. The non-transitory computer-readable storage media of claim 12, wherein the node is moved outward with respect to an interior of the at least one zone.

15. The non-transitory computer-readable storage media of claim 11, wherein each zone topological map comprises at least one node that is fixed from movement during merging.

16. The non-transitory computer-readable storage media of claim 11, wherein merging at least partially comprises inserting at least one dummy node between the first zone topological map with and the second zone topological map.

17. The non-transitory computer-readable storage media of claim 11, wherein merging at least partially comprises clustering nodes of the first zone topological map and the second zone topological map as clustered nodes and replacing the clustered nodes with a single node.

18. The non-transitory computer-readable storage media of claim 11, wherein generating a zone topological map at least partially comprises placing one or more objects within a zone, each object having at least one node associated therewith.

19. The non-transitory computer-readable storage media of claim 18, wherein each object is selected from a library of objects and represents at least one tasks and at least a portion of the material flow.

20. The non-transitory computer-readable storage media of claim 11, wherein each node is associated with a set of node properties that represents properties of a space modeled by the respective node.

21. A system, comprising:
one or more processors; and
a computer-readable storage device coupled to the one or more processors and having instructions stored thereon which, when executed by the one or more processors, cause the one or more processors to perform operations for multi-dimensional shape transfer between digital models, the operations comprising:
providing, within a facility design platform, a set of parameters;
generating, by a layout generation module of the facility design platform, a set of zones at least partially based on the set of parameters, each zone associated with a set of tasks to be performed therein based on a material flow through the facility during execution of a process;
for each zone in the set of zones, automatically generating a zone topological map defined as a zone graph comprising a set of nodes and a set of edges, the set of nodes comprising a set of area nodes and a set of terminal nodes, each area node representing a path that can be traveled along within the facility, each terminal node representing locations of the facility where at least one task is performed and is temporarily occupied during execution of the process; and
merging, by the layout generation module, two or more zone topological maps to provide a facility topological map that models space, through which mobile agents traverse the facility and within which the mobile agents execute one or more tasks, merging at least partially comprising connecting at least one node of a first zone topological map with at least one node of a second zone topological map by an edge.

22. The system of claim 21, wherein merging comprises moving a node of at least one zone topological map.

23. The system of claim 22, wherein the node is moved laterally along an edge of the at least one zone.

24. The system of claim 22, wherein the node is moved outward with respect to an interior of the at least one zone.

25. The system of claim 21, wherein each zone topological map comprises at least one node that is fixed from movement during merging.

26. The system of claim 21, wherein merging at least partially comprises inserting at least one dummy node between the first zone topological map with and the second zone topological map.

27. The system of claim 21, wherein merging at least partially comprises clustering nodes of the first zone topological map and the second zone topological map as clustered nodes and replacing the clustered nodes with a single node.

28. The system of claim 21, wherein generating a zone topological map at least partially comprises placing one or more objects within a zone, each object having at least one node associated therewith.

29. The system of claim 28, wherein each object is selected from a library of objects and represents at least one tasks and at least a portion of the material flow.

30. The system of claim 21, wherein each node is associated with a set of node properties that represents properties of a space modeled by the respective node.
